(19) United States
(12) Patent Application Publication
(10) Pub. No.: US 2007/0190869 A1
(43) Pub. Date: Aug. 16, 2007

(54) Free lock connector

(76) Inventor: Kyung Mo Sung, Seoul (KR)

Correspondence Address: IPLA P.A., 3580 WILSHIRE BLVD., 17TH FLOOR, LOS ANGELES, CA, 90010, US

(21) Appl. No.: 10/598,485

(22) PCT Filed: Apr. 21, 2005
(86) PCT No.: PCT/KR05/01140

§ 371 Date: Aug. 31, 2006

(30) Foreign Application Priority Data
Apr. 21, 2004 (KR) 10-2004-0027479

(51) Int. Cl. H01R 4/10

(52) U.S. Cl. 439/877

(57) ABSTRACT

Disclosed herein is a connector for connecting a film wire to a substrate without a flip member. The connector comprises a housing with an insert hole formed therethrough, and a number of terminals inserted and fixed to the housing through the insert hole. Each terminal comprises a contact portion formed at one side thereof, and a seesaw member integrally formed at the other side thereof opposite to the contact portion via a central portion to seesaw about the central portion by a film wire when the film wire is inserted into the housing. The film wire is inserted into the housing with smaller force at an initial stage, and is fixed into the connector with a greater force at a final stage, so that a contact pin of the film wire can be inserted into a proper position without being damaged or scratched, and be stably fixed in the connector.

### TECHNICAL FIELD

The present invention relates to a film wire-locking connector, which is fixed to a substrate and allows a film wire to be conveniently connected to a terminal and the substrate.

In particular, the present invention relates to a film wire-locking connector, which enables a film wire to be conveniently and stably received in the connector without damage of a contact of the film wire when vertically or horizontally connecting the film wire to a substrate.

### BACKGROUND ART

Conventionally, connectors have been known in the prior art, which are fixed to a substrate, and connect terminals to a cable on the substrate to apply electrical signal therethrough. The conventional connectors can be classified into a horizontal connector to horizontally connect the film wire to the substrate, and a vertical connector to vertically connect the film wire to the substrate.

The connectors including the horizontal connector and the vertical connector can also be classified into a general connector which does not comprise a flip member to fix the film wire, and a flip-type connector, which comprises a flip member and fixes the film wire by closing the flip member after inserting the film wire with the flip member open.

Accordingly, the general connector includes a vertical connector which vertically connects the film wire to the substrate without using the flip member, as shown in FIG. 11, and a horizontal connector which horizontally connects the film wire to the substrate without using the flip member, as shown in FIG. 12.

That is, as shown in FIGS. 11 and 12, a connector 60 or 70 comprises a housing 61 or 71 having an insert hole 62 or 72 formed therethrough, and a plurality of terminals 63 or 73, each of which is formed with a resilient contact portion 64 or 74, so that, when a film wire 65 or 75 is inserted into the insert hole 62 or 72 of the housing 61 or 71, the contact portion 64 or 74 is brought into intimate contact with a contact pin 66 or 76 of the film wire 65 or 75 via resilient force of the contact portion 64 or 74 to connect the film wire 65 or 75 to a substrate.

### DISCLOSURE OF INVENTION

Technical Problem

As such, since the connector 60 or 70 is adapted to allow the film wire 65 or 75 to be directly inserted into the insert hole 62 or 72 of the housing 61 or 71, the connector 60 or 70 can be minimized in size, and does not require a space to connect the film wire 65 or 75 to the connector 60 or 70, which provides an advantage of reducing product dimensions. However, when inserting the film wire 65 or 75 into the insert hole 62 or 72, the contact pin 66 or 76 of the film wire 65 or 75 remains in contact with the contact portion 64 or 74 of the terminals 63 or 73, causing a problem in that the contact pin 66 or 76 of the film wire 65 or 75 can be scratched or damaged.

In particular, since it is necessary to continuously apply force to the film wire 65 or 75 in order to prevent friction between the film wire 65 or 75 and the contact portion 64 or 74 when inserting the film wire 65 or 75 into the connector 60 or 70, it is difficult to insert the film wire 65 or 75, and to confirm that the film wire 65 or 75 is accurately inserted into a proper position within the connector 60 or 70. Additionally, since the film wire 65 or 75 must be fixed by the resilient force of the contact portion 64 or 74, the connector has a problem of weak fixing force.

Meanwhile, the flip-type connector includes a vertical connector which vertically connects the film wire to the substrate using the flip member, as shown in FIG. 13, and a horizontal connector which horizontally connects the film wire to the substrate using the flip member, as shown in FIG. 14. As shown in FIGS. 13 and 14, a connector 80 and 90 comprises a flip member 83 and 93, a housing 81 or 91 having an insert hole 82 or 92 formed therethrough, and a plurality of terminals 85 or 95, each of which has a contact portion 86 or 96. When a film wire 87 or 97 is inserted into the insert hole 82 or 92 of the housing 81 or 91 after opening the flip member 83 and 93, a contact pin 88 or 98 of the film wire 87 or 97 is not brought into contact with the terminal 85 or 95 of the connector 80 and 90 during insertion of the film wire 87 or 97 into the insert hole 82 or 92. Then, when the flip member 83 and 93 is closed, a protrusion 84 or 94 formed on the flip member 83 or 93 is brought into intimate contact with the contact portion 86 or 96 of the terminal 85 or 95 to apply current therethrough.

However, the connector 80 or 90 using the flip member 83 or 93 requires a space to open or close the flip member 83 or 93 by hand above the substrate, causing limitation in reducing the product dimensions. Additionally, the flip member 83 or 93 must be hingably equipped to and fixed to the connector 80 or 90 after being closed, causing an increase of manufacturing costs, and difficulty in reducing the size of the connector. Moreover, for the connector 80 or 90 using the flip member 83 or 93, the flip member 83 and 93 can be easily opened if force is applied to the film wire 87 or 97 by external impact or vibration, and can be released from the connector 80 or 90 immediately after the flip member 83 or 93 is opened, lowering reliability of the product. Moreover, since the film wire 87 or 97 is inserted into the connector 80 or 90 without contacting the contact portion 86 or 96, and is fixed by the flip member 83 or 93, it cannot be confirmed that the flexible film wire 87 or 97 is inserted to a proper position of the connector 80 or 90.

Technical Solution

The present invention has been made in view of the above and other problems, and an aspect of the present invention is to provide a film wire-locking connector, for connecting a film wire to a substrate without a flip member, which allows the film wire to be inserted into a housing of the connector with a smaller force at an initial stage, and then to be fixed into the connector with a greater force at a final stage, so that a contact pin of the film wire can be inserted into a proper position of the terminal without being damaged or scratched, and can be stably fixed therein.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a vertical connector having terminals according to one embodiment of the present invention;

FIG. 2 is a perspective view illustrating a horizontal connector having terminals according to one embodiment of the present invention;

FIGS. 3 and 4 are cross-sectional views illustrating operation of the vertical connector having the terminals according to one embodiment of the present invention;

FIGS. 5 and 6 are cross-sectional views illustrating operation of the horizontal connector having the terminals according to one embodiment of the present invention;

FIGS. 7 and 8 are cross-sectional views illustrating operation of a vertical connector having terminals according to another embodiment of the present invention;

FIGS. 9 and 10 are cross-sectional views illustrating operation of a horizontal connector having the terminals according to the other embodiment of the present invention;

FIG. 11 is a longitudinal cross-sectional view illustrating a conventional vertical connector without a flip member;

FIG. 12 is a longitudinal cross-sectional view illustrating a conventional horizontal connector without the flip member;

FIG. 13 is a longitudinal cross-sectional view illustrating a conventional vertical connector including a flip member; and

FIG. 14 is a longitudinal cross-sectional view illustrating a conventional horizontal connector including the flip member.

### BEST MODE FOR CARRYING OUT THE INVENTION

Reference will now be made in detail to the embodiments of the present invention with reference to the accompanying drawings.

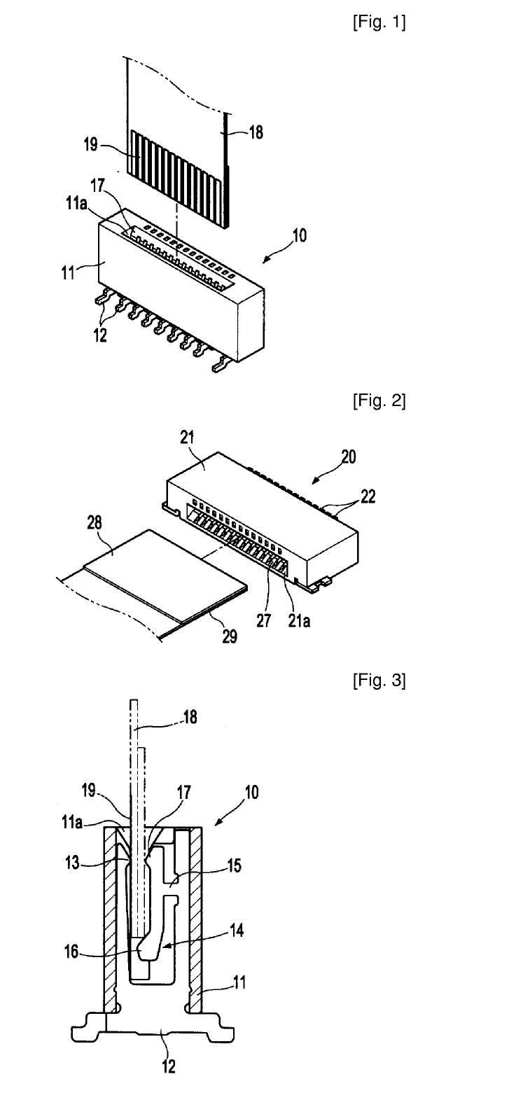

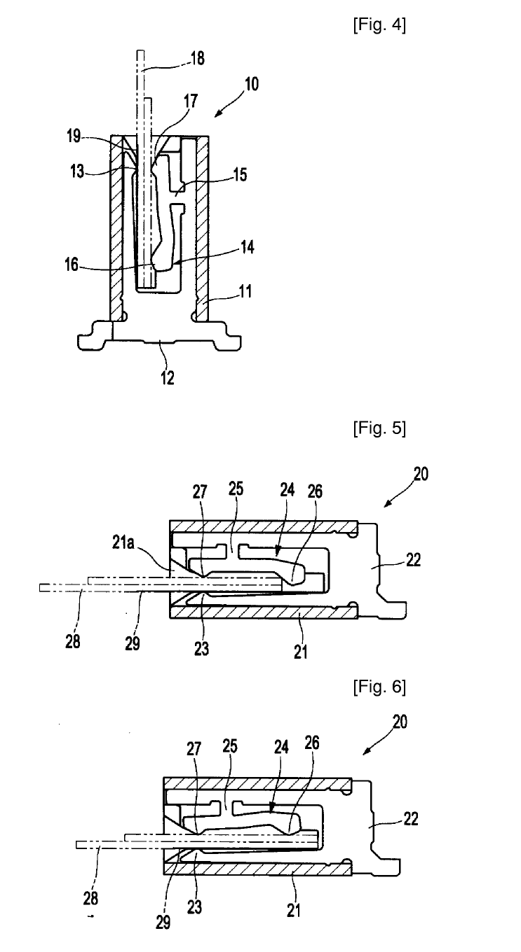

FIGS. 1 to 6 are perspective views and cross-sectional views illustrating connectors according to one embodiment of the present invention.

Referring to FIGS. 1 to 6, a vertical or horizontal connector 10 or 20 for a film wire comprises a housing 11 or 21 having an insert hole 11a or 21a, and a number of terminals 12 or 22 inserted in and fixed to the housing 11 or 21. The vertical or horizontal connector 10 or 20 is adapted to allow a contact pin 19 or 29 of the film wire 18 or 28 to be brought into intimate contact with a contact portion 13 or 23 of each terminal 12 or 22 when the film wire 18 or 28 is inserted into the housing 11 or 21 through the insert hole 11a or 21a. Each terminal 12 or 22 of the connector 10 or 20 comprises the contact portion 13 or 23 formed at one side of the terminal, and a seesaw member 14 or 24 integrally formed at the other side of the terminal opposite via a central portion 15 or 25 to the contact portion 13 or 23 to seesaw about the central portion 15 or 25 by the film wire 18 or 28.

The seesaw member 14 or 24 integrally formed to each terminal 12 or 22 via the central portion 15 or 25 comprises a protrusion 16 or 26 formed at one side of the central portion 15 or 22, and a compressing portion 17 or 27 formed at the other side of the central portion 15 or 22.

In the seesaw member 14 or 24, the compressing portion 17 or 27 is formed to face the contact portion 13 or 23 of the terminal 12 or 22, and is separated from the contact portion 13 or 23 by a distance greater than or equal to a thickness of the film wire 18 or 28 having the contact pin 19 or 29. Additionally, the protrusion 16 or 26 opposite to the compressing portion 17 or 27 forms a gap in front of the protrusion 16 or 26 to have a distance smaller than the thickness of the film wire 18 or 28 having the contact pin 19 or 29.

With such a structure of the invention, when the film wire 18 or 28 is inserted into the vertical or horizontal connector 10 or 20, the contact pin 19 or 29 of the film wire 18 or 28 is not brought into contact with the contact portion 13 or 23 of the terminal 12 or 22 until a portion of the film wire 18 or 28 corresponding to about 75% of a length of the film wire 18 or 28 is inserted into the housing 11 or 21, and then, the film wire 18 or 28 is stably fixed to the housing 11 or 21 by the seesaw member 14 or 24 when the remainder of the film wire 18 or 28 corresponding to about 25% of the length of the film wire 18 or 28 is inserted into the housing 11 or 21.

That is, when the film wire 18 or 28 is inserted through the insert hole 11a or 21a of the housing 11 or 21 having the seesaw member 14 or 24 provided at the other side of the terminal 12 or 22, the contact pin 19 or 29 of the film wire 18 or 28 is inserted between the contact portion 13 or 23 of the terminal 12 or 22 and the compressing portion 17 or 27 of the seesaw member 14 or 24.

At this time, since the gap between the contact portion 13 or 23 and the compressing portion 17 or 27 is greater than or equal to the thickness of the film wire 18 or 28 having the contact pin 19 or 29, the contact pin 19 or 29 of the film wire 18 or 28 can be inserted through the insert hole 11a or 21a of the housing 11 or 21 without scratching or damaging the contact portion 13 or 23 of the terminal 12 or 22.

When about 75% of the film wire 18 or 28 is inserted into the housing 11 or 21, the leading end of the film wire 18 or 28 contacts the protrusion 16 or 26 of the seesaw member 14 or 24.

At this time, since the protrusion 16 or 26 of the seesaw member 14 or 24 forms the gap against a portion of the terminal 12 or 22 in front of the protrusion 16 or 26 to have the distance smaller than the thickness of the film wire 18 or 28 having the contact pin 19 or 29, the leading end of the film wire 18 or 28 is brought into contact with the protrusion 16 or 26. Accordingly, when pushing the film wire 18 or 28 into the housing 11 or 21, the film wire 18 or 28 pushes the protrusion 16 or 26 laterally, and the remainder of the film wire 18 or 28 is then inserted into the housing 11 or 21. At the same time, as the protrusion 16 or 26 is pushed, the seesaw member 14 or 24 seesaws about the central portion 15 or 25, and forces the compressing portion 17 or 27 to compress the film wire 18 or 28.

When the compressing portion 17 or 27 compresses the film wire 18 or 28 via seesawing of the seesaw member 14 or 24, the contact pin 19 or 29 of the film wire 18 or 28 is brought into intimate contact with the contact portion 13 or 23 of the terminal 12 or 22, so that the contact pin 19 or 29 of the film wire 18 or 28 contacts the contact portion 13 or 23 without being scratched or damaged.

Additionally, when the compressing portion 17 or 27 compresses the film wire 18 or 28 in a state wherein most of the film wire 18 or 28 is inserted into the end of the housing as described above, scratches are not formed from the compressed portion to the leading end of the film wire 18 or 28, so that the film wire 18 or 28 can be further stably fixed in the connector 10 or 20, and prevented from being released therefrom by external force.

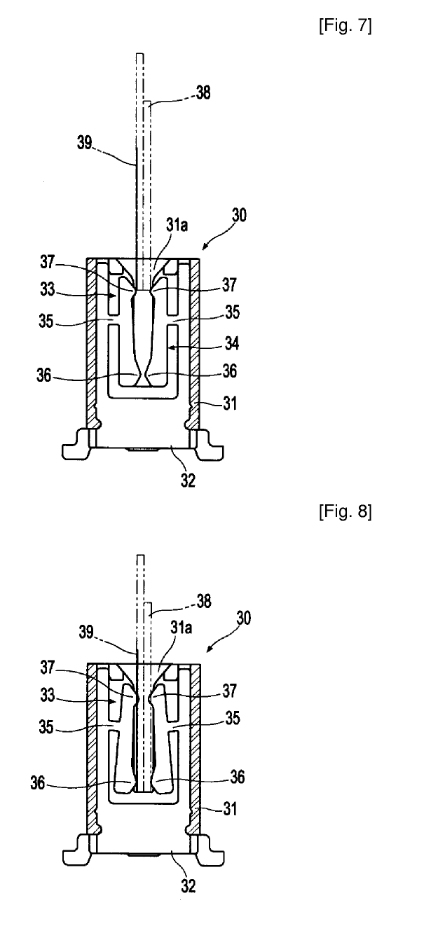

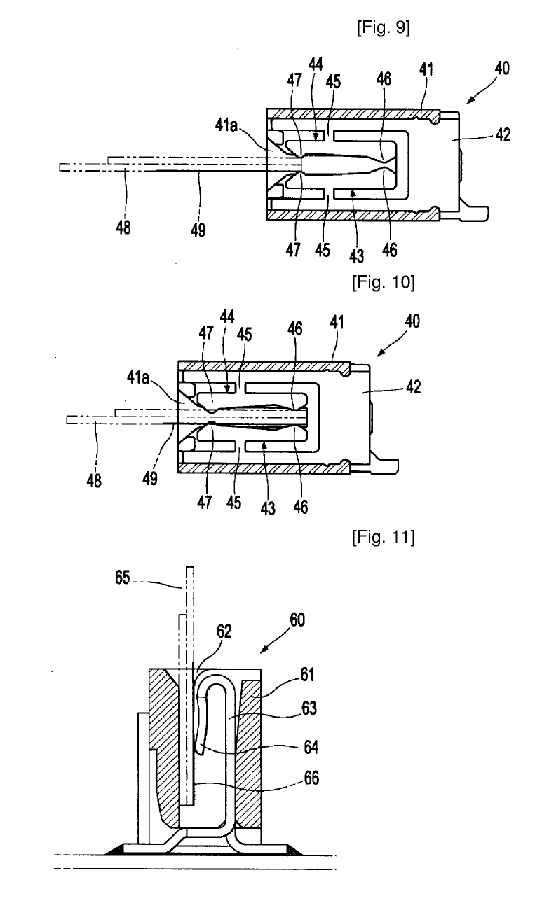

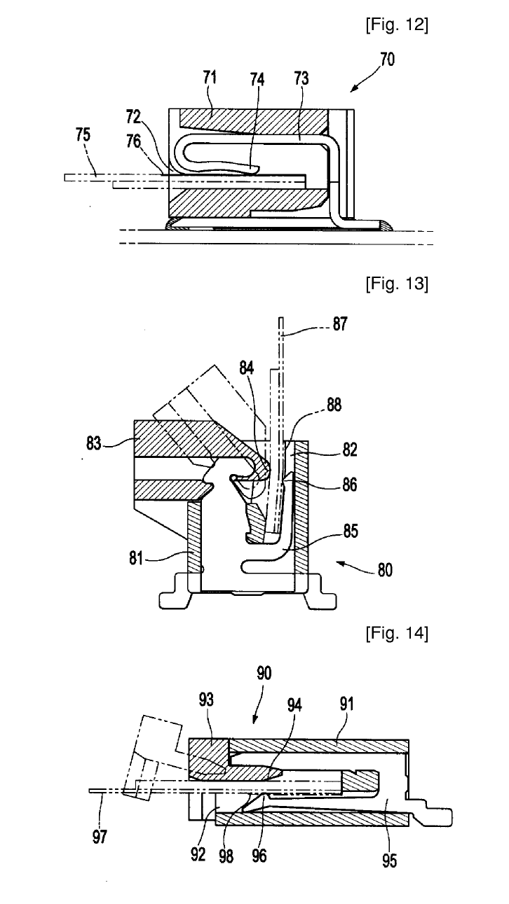

FIGS. 7 to 10 are cross-sectional views illustrating connectors according to another embodiment of the invention.

Referring to FIGS. 7 to 10, a connector 30 or 40 for a film wire comprises a housing 31 or 41 having an insert hole 31a or 41a, and a number of terminals 32 or 42 inserted and fixed to the housing 31 or 41. The connector 30 or 40 is adapted to allow a contact pin 39 or 49 of the film wire 38 or 48 to be connected to a substrate via the terminals 32 or 42 when the film wire 38 or 48 is inserted into the housing 31 or 41 through the insert hole 31a or 41a. Each terminal 32 or 42 of the connector 30 or 40 comprises a pair of seesaw members 33 and 34; 43 and 44 formed to face each other within the housing 31 or 42. The pair of seesaw members 33 and 34; 43 and 44 is integrally formed to the terminal 32 or 42 via a central portion 35 or 45, and seesaws at the same time by the film wire 38 or 48.

Each of the seesaw members 33 and 34; 43 and 44 has a protrusion 36 or 46 formed at one side of the central portion 35 or 45, and a compressing portion 37 or 47 formed at the other side of the central portion 35 or 45.

Preferably, in the pair of seesaw members 33 and 34; 43 and 44, the protrusions 36 or 45 face each other, and form a gap therebetween, the distance of which is smaller than a thickness of the film wire 38 or 48 having the contact pin 39 or 49, and the compressing portions 37 or 47 face each other, and form a gap therebetween, the distance of which is greater than or equal to the thickness of the film wire 38 or 48 having the contact pin 39 or 49.

As such, according to the present embodiment, the connector 30 or 40 comprises the terminals 32 or 42, each of which has the pair of seesaw members 33 and 34; 43 and 44 formed to face each other, so that the film wire 38 or 49 can be fixed into the connector 30 or 40 more stably, and the contact pin 39 or 49 of the film wire 38 or 49 can be connected to the substrate via the terminal 32 or 42.

That is, when the film wire 38 or 48 is inserted into the connector 30 or 40 having the terminal 32 or 42, a leading end of the film wire 38 or 48 having the contact pin 39 or 49 is inserted between the compressing portions 37 or 47.

At this time, since the gap between the compressing portions 37 or 47 is greater than or equal to the thickness of the film wire 38 or 48 having the contact pin 39 or 49, the contact pin 39 or 49 of the film wire 38 or 48 can be inserted through the insert hole 31a or 41a of the housing 31 or 41 without being scratched or damaged by the compressing portions 37 or 47.

When about 75% of the film wire 38 or 48 is inserted into the housing 31 or 41, the leading end of the film wire 38 or 48 is brought into contact with the protrusions 36 or 46 of the pair of seesaw members 33 and 34; 43 and 44 formed to define the gap therebetween, which has the distance smaller than the thickness of the film wire 38 or 48 having the contact pin 39 or 49. Accordingly, when pushing the film wire 38 or 48 into the housing 31 or 41, the film wire 38 or 48 pushes and widens the protrusions 36 or 46 laterally, and the remainder of the film wire 38 or 48 is then inserted into the housing 31 or 41.

At the same time, as the protrusions 36 or 46 are pushed, the seesaw members 33 and 34; 43 and 44 seesaw about the central portion 35 or 45, and force the compressing portions 37 or 47 to compress the film wire 18 or 28, so that the contact pin 19 or 29 of the film wire 18 or 28 is connected to the terminals 32 or 42 without being scratched or damaged. The compressing portions 37 or 47 compress the film wire 38 or 48 in a state wherein most of the film wire 38 or 48 is inserted into the housing, and thus scratches are not formed by the compressing portions 37 or 47 from the compressed portion to the leading end of the film wire 38 or 48, so that the film wire 38 or 48 can be further stably fixed to the connector 30 or 40.

### INDUSTRIAL APPLICABILITY

One of the advantages of the present invention is that the connector for connecting a film wire to a substrate without using a flip member enables the film wire to be inserted into a housing of the connector with smaller force at an initial stage, and then fixed into the connector with a greater force at a final stage, so that a contact pin of the film wire can be inserted into a proper position of the terminal without being damaged or scratched, and can be stably fixed therein.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A connector for locking a film wire, the connector comprising a housing with an insert hole formed therethrough and a number of terminals inserted and fixed to the housing through the insert hole and being adapted to allow a contact pin of the film wire to be brought into intimate contact with a contact portion of each terminal when the film wire is inserted into the housing through the insert hole, wherein each terminal of the connector comprises the contact portion formed at one side of the terminal, and a seesaw member integrally formed at the other side of the terminal opposite to the contact portion via a central portion to seesaw about the central portion by the film wire when the film wire is inserted into the housing.

2. The connector according to claim 1, wherein the seesaw member integrally formed to each terminal via the central portion comprises a protrusion formed at one side of the central portion, and a compressing portion formed at the other side of the central portion.

3. The connector according to claim 1, wherein the compressing portion of the seesaw member is formed to face the contact portion of the terminal while being separated from the contact portion by a distance greater than or equal to a thickness of the film wire having the contact pin, and the protrusion opposite to the compressing portion forms a gap in front of the protrusion to have a distance smaller than the thickness of the film wire having the contact pin.

4. A connector for locking a film wire, the connector comprising a housing having an insert hole formed therethrough and a number of terminals inserted and fixed to the housing, and being adapted to allow a contact pin of the film wire to be connected to a substrate via the terminals when the film wire is inserted into the housing through the insert hole, wherein each terminal of the connector comprises a pair of seesaw members formed to face each other within the housing, and integrally formed to the terminal via a central portion to seesaw by the film wire when the film wire is inserted into the housing.

5. The connector according to claim 4, wherein each of the seesaw members has a protrusion formed at one side of the central portion, and a compressing portion formed at the other side of the central portion.

6. The connector according to claim 4, wherein, in each pair of seesaw members, the protrusions face each other while forming a gap therebetween to have a distance smaller than a thickness of the film wire having the contact pin, and the compressing portions face each other while forming a gap therebetween to have a distance greater than or equal to the thickness of the film wire having the contact pin.
